(19) United States
(12) Patent Application Publication
(10) Pub. No.: US 2013/0345951 A1
(43) Pub. Date: Dec. 26, 2013

(54) ENGINE PERFORMANCE MODIFICATION OR TUNING KIT

(71) Applicants: Edward Zyla, Eccles Manchester (GB); Mark Howarth, Ramsbottom Bury Lancashire (GB)

(72) Inventors: Edward Zyla, Eccles Manchester (GB); Mark Howarth, Ramsbottom Bury Lancashire (GB)

(73) Assignee: MOBILIZER LIMITED, Bolton (GB)

(21) Appl. No.: 14/003,987

(22) PCT Filed: Mar. 9, 2012
(86) PCT No.: PCT/GB2012/050532

§ 371 Date: Sep. 9, 2013

(30) Foreign Application Priority Data
Mar. 9, 2011 (GB) 1104029.2

(51) Int. Cl. F02D 41/26

(52) U.S. Cl. CPC F02D 41/26
USPC 701/104

(57) ABSTRACT

A performance modification/tuning kit for an internal combustion engine of the type comprises a kit control unit. An electrical sensor is adapted to detect the opening and closing signals of a control line to one of the injectors of the engine and connected through a sensor line to the control unit. An input receives the signal from a pressure sensor of the common fuel rail of the engine and an output report a generated pressure signal to the engines ECU. A selectively changeable modification map, comprising modification values for a range of different engine speeds and fuel loads demanded by the ECU is used by the kit control unit to generate the generated pressure signal. That is generated in dependence upon the value in the modification map for the engine fuel load Q currently demanded by the ECU and the engine speed currently pertaining from time to time.

This invention relates to a tuning kit for modifying the performance of common rail internal combustion engines, in particular, diesel engines.

### BACKGROUND

A common rail diesel (or petrol) engine has a manifold (the common rail) containing fuel that is under pressure (which pressure is monitored by an engine management unit (ECU)) and a number of injectors supplied by the manifold and connected to each cylinder of the engine. The ECU also controls the injectors and opens each in defined sequence and for controlled periods of time to admit fuel into the engine at the appropriate point(s) of the engine 4-stroke cycle.

The volume of fuel injected in any given engine cycle is obviously a function of the time period that an injector is open during that cycle and the pressure pertaining in the manifold. In fact, it is largely directly proportional to the time, and approximately proportional to the square root of the fuel pressure. The ECU controls the amount of fuel to be injected, both by varying the pressure and the time period of injector opening. It does so under the control of an engine management map that takes into account a plethora of factors including, of course, throttle position and existing engine speed. But many other factors are also frequently taken into account and one of those is certainly (in modern vehicle engines for instance) emission requirements.

The fuel pressure is controlled, on the one hand, by varying the operation of a fuel pump supplying the manifold and, on the other hand, by opening and closing a bypass valve that vents the manifold and returns vented fuel to the pump. The fuel pressure achieved is monitored by a pressure sensor that reports to the ECU, and the ECU controls the pump and bypass valve accordingly. Indeed, the sensor is assumed to be correct. If it reports a lesser pressure than actually pertaining in the common rail, the ECU increases fuel pressure. This continues until such time as the ECU recognises that there must be a fault in the system (since its control of the pump and bypass valve should ordinarily result in a (much) different pressure than that being reported). When that occurs, the engine reverts to some fault-mode of operation, and warns the operator accordingly.

Because of the desire to reduce emissions, engine management systems are generally arranged to provide air to the combustion chambers substantially in excess of stoichiometric (or put another way, less fuel than is stoichiometric), whereby the possibility of unburnt hydrocarbon entering the exhaust gases is minimised. However, it is apparent that merely by increasing the ratio of fuel to air, the performance of modern engines can be affected.

It is known to interrupt the reporting signal of the fuel pressure sensor and to reduce (or increase) the apparent pressure so that the engine management system adjusts the performance of the fuel pump and/or its bypass valve to adjust the fuel pressure to a desired value that is different from the value the engine management system is attempting to impose.

The reported pressure may be increased in those cases where it is desired to degrade the performance of the engine. However, reporting a higher pressure might also be done when a second, or perhaps higher thermal value, fuel is being employed. It is known to use dual fuels, for example mixing petroleum gas (LPG) with diesel fuel. Although LPG has less calorific value than diesel, it can assist with ensuring complete combustion of the diesel fuel. Also, since it is cheaper to purchase (at least at present) than diesel fuel, it is economically more efficient to use it as at least part of the fuel load for the engine. In this instance, if the fuel pressure sensor reports to the ECU a higher pressure of fuel in the common rail than actually pertains, the ECU adjusts down the volume of fuel injected, whereby separate injection of the second fuel can make up the correct fuel load requirement.

It is also known to adjust the mapping of fuel delivered to an engine. This can be done in several ways. One way, commonly referred to as “chipping” is to modify within the ECU the base fuel mapping of the vehicle's engine originally installed by the manufacturer. (Despite the following discussion being primarily concerned with diesel engine vehicles, the teaching herein applies as much to other engine types in other situations, which may or may not be vehicular.) This may involve reprogramming the software of the engine management system. It is relatively simple to do, provided the relevant software is known and can be reprogrammed as desired. A problem with this method is that engine mapping is frequently reloaded by garages when they complete service schedules for a vehicle. This can therefore overwrite a modified program. Moreover, such fundamental tampering with the vehicle computing function involves a detailed knowledge of that function and is often unique to specific vehicles.

A second method of remapping employs a ubiquitous “black box” interposed between the ECU and the fuel delivery system, that is, either or both of the fuel pressure sensor and the injectors. A control algorithm in the box adjusts one or both aspects of engine management according to a pre-set scheme. A problem with such a unit is that it is generally not possible to make fuel adjustments at specific engine speeds or loads. Moreover, the inability to specify under what conditions an increase or decrease in fuel should occur can trigger engine management fault codes or cause drivability issues. This limits the level of fuel adjustment that can be made. For example, existing kits that under-report the fuel pressure by, say, 10% or 20%, may be satisfactory at some engine performance levels, but, at others, such substantial change may cause an engine error code to be generated. Indeed, at low engine loads it is seldom desirable to change the fuel quantity injected.

It is an object of the present invention to provide a kit that is adaptable to different engines and different uses on such engines.

WO-A-2009/133399 discloses a system for degrading the performance of an engine by interrupting the opening signal to each injector and modifying the signal, thereby to vary the opening time of the injector. The signal is modified based on one or more of many different parameters depending on the application. However, no specific scheme or algorithm is proposed as such. It is also proposed that the pressure of fuel in a common rail may be monitored and misreported to an engine management system so as to manipulate the actual pressure developed by the fuel pump under the control of the engine management system.

WO-A-2009/115845 discloses a similar arrangement but for a dual fuel vehicle in which a second fuel such as LPG is provided for a diesel engine to improve the combustion of the diesel fuel employed. The system interrupts the injector signal and modifies it according to a preset scheme as well as controlling injection of the second fuel.

### BRIEF SUMMARY OF THE DISCLOSURE

The present invention comprises a performance modification/tuning kit for an internal combustion engine of the type comprising:

a common fuel supply rail for a plurality of combustion chambers of the engine;

a fuel injector for each combustion chamber, each injector supplied by the common rail;

an engine management control unit (ECU) that controls the pressure of fuel in the common rail;

a pressure sensor that monitors the pressure of fuel in the common rail and reports a pressure signal generated by the sensor on a pressure signal line to the ECU; and

a control line from the ECU to each injector to control the opening of each injector, whereby the load Q of fuel injected is dependent on the total opening time of the injector and the fuel pressure in the common rail;

wherein the kit comprises:

a kit control unit;

an electrical sensor adapted to detect the opening and closing signals of the control line to one of the injectors of the engine and connected through a sensor line to the control unit;

an input to receive the signal from the pressure sensor;

an output to report a generated pressure signal; and

a selectively changeable modification map comprising modification values for a range of different engine speeds and fuel loads demanded by the ECU, wherein

the kit control unit generates said generated pressure signal in dependence upon the value in the modification map for the engine fuel load Q currently demanded by the ECU and the engine speed currently pertaining from time to time.

Preferably, when the kit is connected to an engine with the sensor line interrupted and connected from the sensor to the kit control unit input and from the ECU to the kit control unit output, the control unit is adapted to monitor engine speed and instantaneous fuel load based on the opening and closing signals of the sensed injector and the reported fuel pressure;

initially the control unit is adapted to be calibrated by operating the engine in a normal mode, wherein the generated pressure signal is a duplication of the reported pressure signal, and a template for the modification map is developed being a table of fuel load versus engine speed divided in bands between maxima and minima of each of fuel load and engine speed experienced during calibration; and

after calibration, the control unit is adapted to be set in one of several selectable operating modes, wherein the modification map is applied, whereby, at any given engine speed and load, a modification value in the map is applied to adjust the value of the pressure signal received from the pressure sensor and issue the value generated thereby to the ECU through said output.

Thus a kit according to the invention has two effects. First, it can separately map the approximate fuel delivery of an engine (that is, for any engine—provided it employs a common rail and electronic control of fuel injectors) at different engine operating conditions by recording the time T that injectors are open and the pressure P of the fuel rail at the time, using the expression:

Q=k·T·√P 1.
where Q is a volume quantity, k is a constant, T is the aggregate injection opening time and P is the pressure.

The value and units of Q, T and P used by the control unit are irrelevant, provided they are consistent. The end result is a range of values of Q at different operating speeds of the engine, which range approximates to a range of loads imposed on the engine. Indeed, while “load” is frequently used in this specification in reference to work done by the engine, within the context of the present invention what is usually meant, and what it equates to, is the instantaneous fuel quantity delivered at each injection.

During calibration, the speed range of the engine is monitored from idle through to maximum speed. With a modern automobile diesel engine, this is generally in the range 900 to 4500 rpm and approximately 500 to 2200 rpm for heavy goods vehicles. The opening time of the injectors for a range of loads at any given speed is monitored, along with the fuel rail pressure, but since the actual fuel load is unknown, the only useful information is the maximum opening time and pressure (equating to the maximum load) recorded for different speeds. The minimum load (minimum combined opening time and pressure) recorded is also noted for each speed. With these extremes, it is possible to know what fuel load a particular opening time and pressure represents at a particular speed, relative to a given minimum value (or maximum or any other predefined level of fuel load). Thus a template can be derived comprising an x-axis divided into bands of equal ranges of speeds against a y-axis divided into bands of equal fuel load Q. Thus, at any time, if the engine speed and fuel load is known the location on the template at which the engine is operating can be derived. Preferably, the template is divided into 32×32 cells, with 32 load value ranges on the y-axis and 32 speed value ranges on the x-axis.

Once the current fuel load (which equates approximately to an engine work load) and engine speed is known at any given time, it is not necessary to know what actual quantity of fuel is injected at that time; all that is required is to decide how much the fuel pressure signal is to be modified to change the amount of fuel actually delivered. That is where the modification map is employed, which sets a particular variation of the reported fuel pressure for a given engine speed and fuel load.

Thus, the second effect of the kit according to the invention is that the fuel actually to be delivered at a given demanded fuel load can be proportionally adjusted, as may be required and dependent on the user's purpose. In one case, the amount of fuel delivered may be increased, to enhance engine performance. In another case, it may be reduced, to degrade engine performance, or perhaps to allow another fuel to be also employed

It is to be noted that, in most standard situations, the volume of fuel delivered to the engine at any given injection period is determined, primarily, by the fuel rail pressure, which is varied by the ECU. In diesel engines, injection timings are generally only modified during engine acceleration or deceleration. This is because a change in fuel pressure may not be able to keep pace with the changing engine demands. In that event, changing the opening times may result in faster change of fuel supply. However, with diesel engines pressures are in any event much higher, in the range 300-2000 bar. At these pressures, very short opening times are employed in the range 1-2 ms. Petrol engines, on the other hand, operate at much lower pressures, around 10 bar, that are not varied much over the operating range, whereas opening times do vary considerably, from around 2 to 15 ms in duration.

The operating modes that may be incorporated in the kit include:

a normal mode, where the modified pressure signal corresponds to the delivery map and no change in engine performance ensues;

one or more enhanced performance modes, where the modified pressure signal is changed so as to under-report the pressure actually pertaining in the common rail, whereby the engine management system will increase fuel pressure according to its own parametrics; and

one or more detracted performance modes, where the modified pressure signal is changed so as to over-report the pressure actually pertaining in the common rail, whereby the engine management system will decrease fuel pressure according to its own parametrics.

A combination of effects may be employed in some situations. For example, diesel engines in commercial vehicles work best at low speed with high torques. Thus it is feasible to arrange for fuel delivery to be increased at high loads and low speeds, enhancing low speed torque of the engine, whereas at high speed for the fuel delivery to be reduced encouraging the driver to change gear and maintain operation of the engine at the low-speed/high-torque end of the engine spectrum.

If there is more than one enhanced or detracted performance mode, the degree of over- or under-reporting will be different between the plurality of modes in each case. It may be that there is only one mode, in the sense of one modification map being stored by the kit, with the possibility of adaptation of the map as may be desired, or several maps may be retained in memory.

For the avoidance of doubt, “parametric” as used herein means the application of parameters by a system according to relationships within the system that establishes a response by the system to those parameters.

Preferably, the kit includes a display and operator interface, connectible to the control unit, whereby the modification map may be modified by a user of the kit. Preferably, the display enables the modification map, or an approximation thereof, to be displayed.

In its simplest form, the display may be lights or sounds, indicating the modification map currently being applied. The operator interface may comprise one or more switches enabling selection of a modification map. The connection with the control unit may be wireless, in which event the display and interface will be self-powered and may be embodied in a pocket-sized unit. “Pocket sized” means fitting within a compartment of size 15 cm×10 cm×3 cm. One convenient form of display and interface is in the form of a key fob. The display may comprise one or more LEDs.

In another embodiment, suitable especially for operators fitting the kit to an engine, the display may be a screen capable of displaying a selected modification map that may comprise an average percentage change parameter with respect to each location of the fuel delivery map, or an approximation thereof. An “approximation” of a modification map, (said modification map comprising m by n fields or cells) may comprises a by b fields where m, n, a and b are integers. Any given field (a,b) of the approximation map may be an average value of a corresponding range (m₁-m₂, n₁-n₂) of the modification map. Thus, where (m×n) is, say (15×30), where m is load and n is speed, (a×b) may be (3×5) where the top five loads are grouped together in the approximation map (as High Load), the middle five loads are grouped together (as Middle Load) and the bottom five are grouped together (as Low Load), and the engine speeds are grouped in five groups of six. However, it is not necessary that a and b be whole factors of m and n respectively. In fact, not only is it not necessary but also it may be desirable to have ranges of speed or load that are different. Where, for example, a range of speeds will have substantially the same modification proposal for the same range of loads, it makes sense to group them together, whereas the modification may change significantly over a small range of speeds elsewhere in the performance spectrum of the engine.

The operator may place a value of 100, for example, in one field of the approximation map. The control unit then arranges for the modification map to have an average value of 100 in the cells of the modification map covered by the corresponding field of the approximation map. If all the cells of the approximation map are valued at 100, then all the cells of the modification map will also be 100. If however, the values of three adjacent cells of the approximation map are different, say 90, 100, 110, then the values of the modification map will be interpolated from the values of the approximation map to smooth steps between adjacent cells in the modification map.

A value of 100 (or any selected value) in the modification map may be read by the control unit to effect no change to the fuel delivery map, whereas a value of 110 may be read to indicate an increase in desired fuel quantity (perhaps by 10%) so that the pressure value reported to the ECU may be u% less than the pressure sensor is indicating (where u is some value that provides a 10% change in fuel quantity). Likewise, a value of 90 may result in the ECU being reported a value u% less than the pressure sensor is indicating.

It is to be understood that the fuel delivery map is itself only an approximation of the actual fuel mapping applied by the ECU, which it is not necessary for the control unit of the present invention to know beyond the effect it has on fuel delivery at different engine speeds and loads. Indeed, although there is a certain circularity in this assessment, because actual loads are not measured or detected beyond the volume of fuel delivered at a given engine speed, nevertheless, fuel delivered is primarily dependent on engine load. Thus, when the present disclosure discusses engine load, what is actually meant is a derived value from the fuel delivered and engine speed.

Thus the present invention allows a range of different modifications to be effected. One such arrangement is to boost the performance of a vehicle. As already mentioned, most car manufacturers, particularly if they are concerned that their vehicles meet challenging emissions targets at all operating conditions, employ a fuel delivery map that is conservative in the sense that there is always excess of air entering the chamber whereby complete combustion can better be assured. This enables performance simply to be enhanced by increasing the balance of fuel and air in favour of a closer stoichiometric ratio. Indeed, a benefit of the invention is that, if emission levels are seen to be excessive at certain loads or speeds, once the kit has been installed, it is possible to adapt the modification map so that areas of the map that result in unacceptable emissions can be adjusted. This advantage is also useful in situations where the modification map is so radical at certain engine speeds and loads that it results in a fault condition being diagnosed at certain points of the map by the ECU, which then puts the engine into an error mode of operation. Such radical points of the modification map can be selectively eliminated so that the fault conditions are not initiated.

A second arrangement is in the opposite sense. It may be desirable to down grade the performance of a vehicle and for this to be effected in real time. For example, inexperienced drivers (especially young men) could be permitted to drive a vehicle when a particular modification map is employed. That map might degrade engine performance or at least govern top speeds and loads, for example.

Engine degradation has other applications, for example in the case of a stolen vehicle. If remote access to the control unit is provided, then the modification map can be changed while the engine is operating to gradually bring the engine, and hence the vehicle, to a standstill.

However, another application of the kit of the present invention is in dual fuel applications. Instead of diesel providing all the fuel for an engine, this is supplemented by LPG or the like. An LPG kit injects gas into the air inlet manifold and supplements the fuel injected by the injectors. It is necessary to concomitantly reduce the injection of diesel, and the kit of the present invention not only enables this to be done, but also provides for the reduction to be adjusted, or even switched-off, to suit particular circumstances.

The interface may be a keypad enabling numbers to be entered in response to menu options displayed on the display.

In typical diesel engines, injectors are driven by a solenoid or by a piezo device. Currents and voltages employed by the engine management unit to drive these devices vary. Great care needs to be taken when interfering with these currents and voltages to ensure that the ECU does not detect a fault condition. The pressure sensor typically reports pressure as a voltage value, usually, however, with very low current (because no work is required to be done by the signal), but otherwise variable between different engines.

Consequently, the sensor connected to the control unit that detects the opening and closing signals of the control line to an injector of the engine preferably does not break into and interrupt the signal, whereby the control unit would be obliged a) to absorb the voltage and current issued by the engine management unit (so as to avoid raising an alarm in that unit) and b) would be obliged to replicate that voltage and current (with or without modification) in order to drive the injectors. Instead, it is preferred that the sensor merely detects the presence of a voltage or current in the control line without interrupting the control line. This has the advantage of isolating the kit of the invention from the injector signals and improving compatibility of the kit with different engines. One form of sensor is a magnetic field sensor that issues a voltage in response to a detection of a changing magnetic field where the issued voltage is proportional to the strength of the detected field. Current flowing in a wire creates a magnetic field around the wire and if that current varies so will the magnetic field, and hence the issued voltage of the magnetic field sensor if that is disposed in vicinity of the control line. Preferably, the sensor is contained within a metallic package closable around the control line to shield the magnetic sensor from the effects of other magnetic fields in the vicinity of the control line. Indeed, the sensor may be fixed in a channel formed by a first metal plate to which a second metal plate is hinged, whereby the shield can be closed around a selected control line engaging the control line against the sensor and locking the sensor to the control line.

Most injectors have two wires connected thereto, one generally carrying the driving signal from the ECU and the other being either a return wire or a power supply wire. In either case, both wires have a varying magnetic field responsive to the injector drive signal, and in substantially identical timeframes. Thus, a sensor as just described has the advantage that it is irrelevant which wire it senses or, indeed, in which direction the sensor is located with respect to the wire: an issued voltage will be provided by the sensor that varies in accordance with the signal in the control line. Nevertheless, the values of the issued voltage depend entirely on the engine and the placement of the sensor. It is necessary therefore to calibrate the sensor in association with the engine on which the kit is implemented.

Calibration firstly involves shaping the issued voltage from the sensor so that it is useable by the control unit. This involves amplification and offsetting to fit in the voltage envelop of the kit's control system. This shaping may be effected by the sensor (or components associated with the sensor) or by the control unit itself. Such shaping preferably involves an iterative process whereby the final signal is manipulated so that it varies between 0v, ½v and 1v, (where v is a reference voltage of the control unit) and has a “base” value that is ½v. Thus the control unit may operate with the rail voltage v being 5 volts, but any suitable voltage may be used. In this case 0v, ½v and 1v, are 0, 2.5 and 5 volts respectively. As well as amplifying the signal as much as necessary to fill the voltage space, the signal is offset with respect to the selected neutral or base value (½v, or 2.5 volts). Indeed, the signal is identified either as one that raises voltage in only one direction from a base line, or one that alternates in value above and below a base line. The former case is generally the signal present when the injector is operated by a solenoid, whereas the latter is the form generally employed when the injector is operated by a piezo element. With both, there is a clear initiation and termination of an injector-operate signal.

In the case of a solenoid valve, the start of the opening signal is taken to be when the voltage value increases more than x% above the base line. Similarly, the closing signal is taken to be when the voltage value decreases to less than y% above the base line. y is generally less than x, whereby the occasion of false triggering is reduced, but they can be the same.

In the case of a piezo driven valve, the start of the opening signal is taken to be when the voltage value increases more than x% above the base line. However, return of the voltage value to the base line does not trigger a closing signal. The closing signal is taken to be when the voltage value decreases to more than y% below the base line. In this case, y is generally the same as x, but they can be different. Of course, in both cases the moment of opening or closing is not the issue. The purpose is to be consistent between different opening and closing events and to reflect accurately a value that is always in the same proportion to the actual opening times, whatever they are in actuality. Thus an actual opening time of 3.00 ms may be recorded by the unit as 2.99 ms but this is of no consequence to the control unit, provided the “inaccuracy” is accurately consistent. Another aspect of the kit is the ability to deal with latency in the opening of the injectors. However, this is within the ability of the skilled person.

One aspect of the present invention is the possibility of ignoring pulses. Modern diesel engine management systems often inject a small amount of fuel during an exhaust stroke so as to scavenge the cylinder. Such pulses are ignored because they are either too short, or are not immediately followed by succeeding pulses, to be a fuel delivery pulse.

Preferably, pulses, and/or groups of pulses, are validated by the system before being considered to reflect an injector opening time. Validation occurs when pulses arrive within an expectation window, which window is created by recording during the calibration phase acceleration and deceleration performance of the engine and predicting, given immediate past performance, when the next pulse would be expected, and then only validating a pulse if it does arrive within that window.

### BRIEF DESCRIPTION OF THE DRAWINGS

Embodiments of the invention are further described hereinafter with reference to the accompanying drawings, in which:

FIG. 1a is a schematic illustration of an engine modification kit according to the present invention,;

FIG. 2 is a detailed view of a sensor for use in the system of FIG. 1;

FIGS. 3(a) to (c) are traces of the voltage signal against time detected by the sensor of

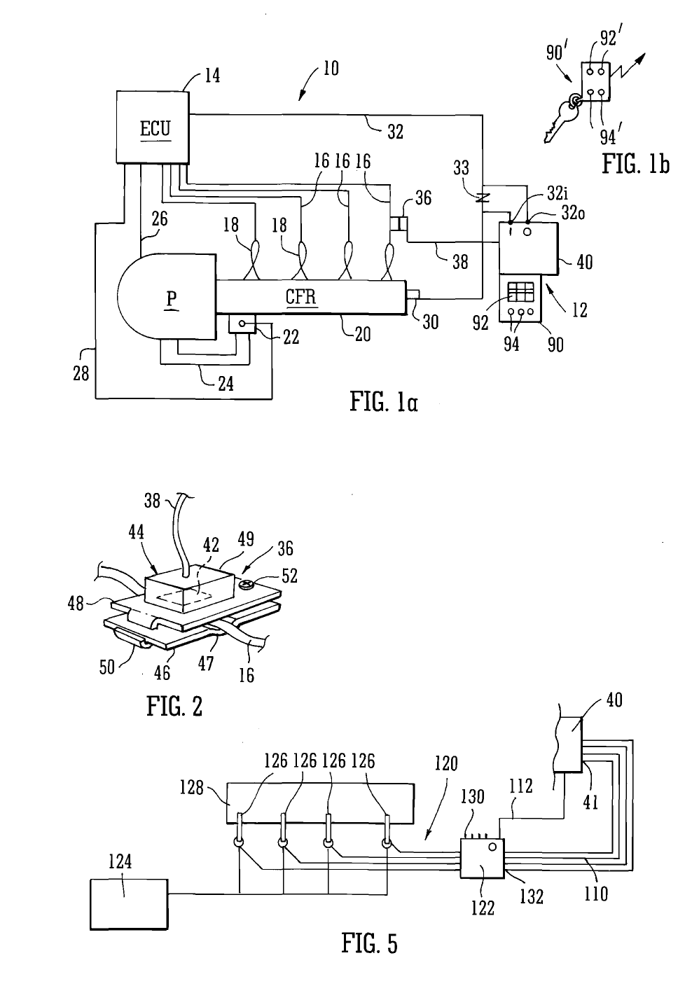

FIG. 2 in a typical engine, and how the signal is manipulated by the system of FIG. 1;

FIGS. 4(a) and (b) are traces of the voltage signal against time detected by the sensor of FIG. 2 in a different engine using piezo-electric injectors, and how the signal is manipulated by the system of FIG. 1;

FIG. 5 is an additional element of a second fuel system being employed with the kit of the present invention;

FIG. 6 is a modification map (only some cells being shown to have values in them) of the engine modification kit according to the present invention;

FIG. 7 is an approximation map employed by a user to populate the modification map of FIG. 6.

### DETAILED DESCRIPTION

Referring to FIG. 1, an engine 10 is modified by incorporation of an engine modification kit 12 in accordance with the invention. Engine 10 comprises an engine management control unit (ECU) 14 that sends opening signals along lines 16 to each of a plurality of injectors 18 that are provided, one for each cylinder (not shown) of the engine.

The injectors 18 are supplied with fuel from a common fuel rail (CFR) 20 that is in turn pressurised by a fuel pump P. The pressure in the fuel rail is controlled by a pressure relief valve 22 that allows fuel to drain from the rail and return to the pump via line 24. Of course, the pressure developed by the pump P is variable and controlled by the ECU along line 26. However, the valve 22 can react much faster to required changes in fuel demand than can the pump itself, and the valve is controlled by the ECU 14 along line 28. The actual pressure developed in the CFR 20 is monitored by a pressure sensor 30, which reports back to the ECU 14 along line 32. When a kit 12 in accordance with the invention is installed in the vehicle (assuming the engine 10 is in a vehicle, which is by no means a requirement of the invention), the line 32 is cut at 33 and two terminals 32i, 32o are fitted on the cut ends and plugged into input I and output O sockets of a control unit 40 of the kit 12.

The kit 12 also comprises a sensor 36 (shown in more detail in FIG. 2). Sensor 36 comprises a magnetic field sensitive chip 42 on the end of a line 38 connected to port T of the control unit 40. Ideally, the chip is contained within a metallic box arrangement 44 that shields the chip from external influences. The box 44 may comprise a base 46 having a groove 47 (extending across the width of the base 46) and a lid 48 having an indent 49 to receive the chip 42. The line 38 extends from the box 44 through the gap formed by the groove 47 where the base 46 abuts the lid 48. However, one of the lines 16 is also captured in the groove 47, which is achieved by the lid and base being separable and securable together by a hinge 50 and screw 52. Of course, any suitable structure will suffice, provided the chip is isolated from extraneous influence and is placed close to the line 16. Suitable Hall effect devices on chips are currently available on the open market.

Line 16 is often one of two for each injector 18, but in either case its current will vary as a pulse in voltage is applied by the ECU 14. Consequently, it does not matter which wire is selected or which orientation is applied, the output on line 38 is a change in voltage corresponding with a change in current in the line 16. Moreover, it is not relevant to the invention which one of the lines 16 the sensor is attached to; what the control unit needs to be informed about is the pulse length and hence the opening times of the injectors 18. This does not vary from cylinder to cylinder and notification of a change in pulse rate (as the engine changes speed and load) once per a full engine cycle is sufficiently rapid for the purposes of the present invention.

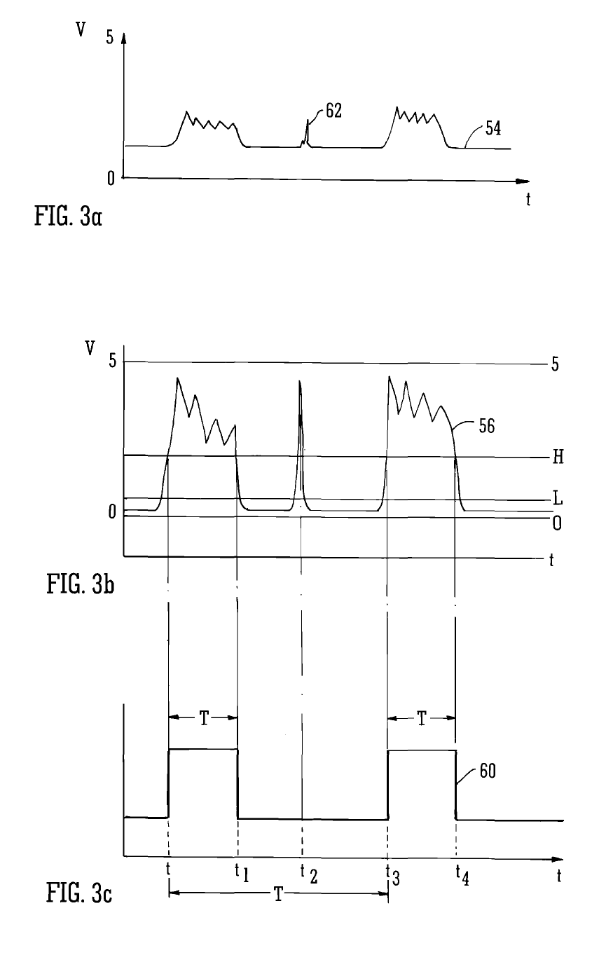

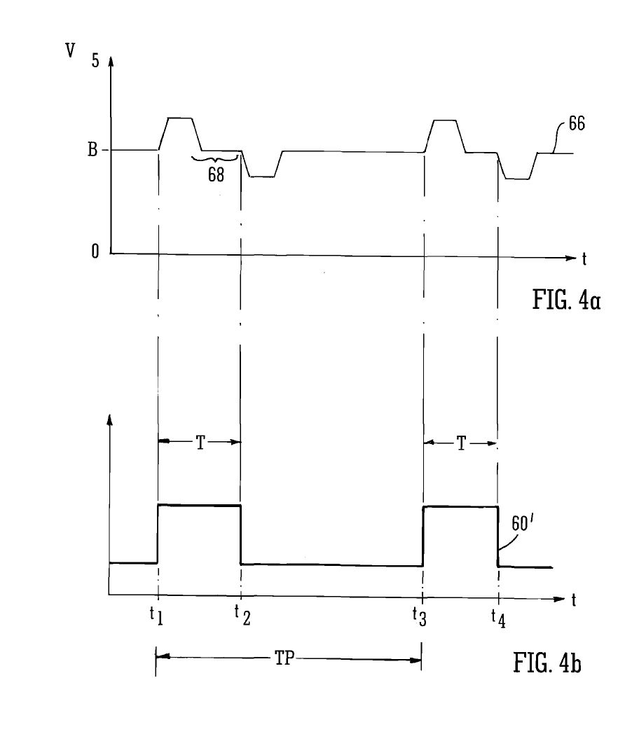

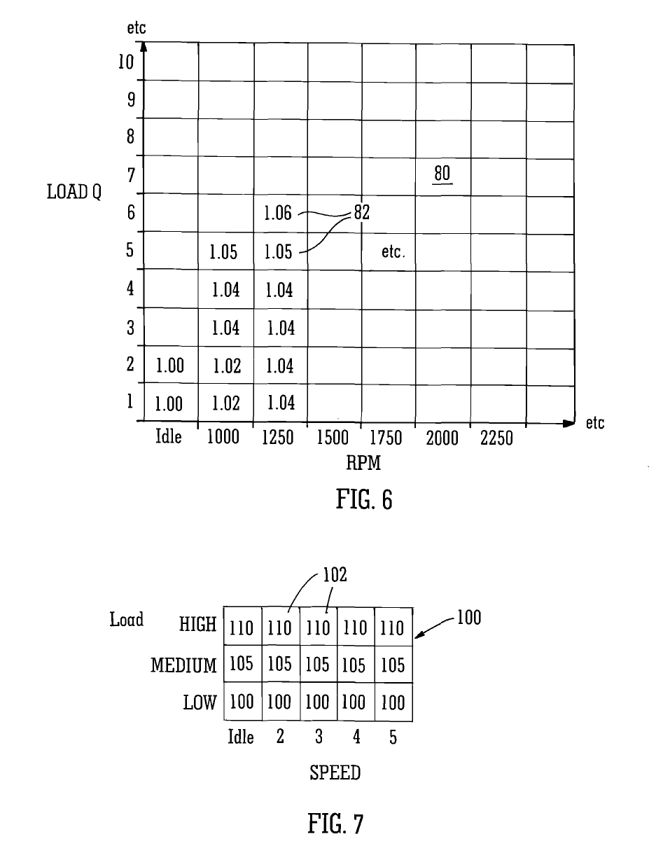

At installation, the control unit 12 requires calibration. What this involves is first recognizing the pulses emanating from ECU on the lines 16 so that they can be processed. A first type of signal that may typically be detected by the sensor 36 may invoke a signal in the line 38 as shown in the waveform 54 in FIG. 3(a). This is a trace of voltage v against time t. It can be seen that the pulse starts with an increase in voltage, then a fluctuating section before a return to a base line. The fluctuating section is not necessarily present, but when it is it is because of the control arrangements in the engine ECU, that rapidly turn on and off the voltage to the injector, and the nature of the injector that does remains open despite the fluctuations. The control unit amplifies the signal 54 to produce a new signal 56 (see FIG. 3(b)) that fills the voltage space available, which may be between 0 and 5 volts. Then, two threshold values are set, being respectively H (eg 20%) and L (eg 3%) of maximum. Thus when the voltage of the signal 56 increases from zero to more that H, this is the point at which the injector is considered to commence opening. Of course, this shape of signal is indicative of a solenoid-operated injector, where a change in voltage from a base line activates the injector to open, an absence of voltage permitting a return spring to close the injector. Thus, when the voltage drops from above to below L, this is the point considered to terminate opening of the injector. A component in the control unit thus switches in square wave fashion as shown by trace 60 in FIG. 3 (c) whereby it can be determined that the injectors remain open for periods T=(t₂-t₁)=(t₄-t₃).

Although the signal 54 shows the injectors being opened continuously for specific periods of time, in fact it is frequently the case that injectors may open for multiple short periods of time in the same engine cycle. However, the control unit recognizes composite pulses by the overall shape of the trace and simply sums the opening times to achieve a cumulative opening time T of the injectors. On the other hand, intermediate pulses 62 (see FIG. 3(a)), which some engines employ for scavenging purposes, do not add to the fuel load during an induction cycle. However, the system can recognize and ignore these.

Turning to FIG. 4(a), a trace 66 demonstrates an alternating voltage from a base line B. The control unit 40 detects that this is the case by first detecting an average voltage (it does this with either type of signal) and noting that there is a drop in voltage below the average base line voltage (value B) as well as rises above it. Thus the baseline voltage B is set at ½v (rather than 0v). Once detected, the control unit understands that this is the form of signal employed by ECUs to control piezo injectors where a piezo stack is switched from one state to another with first a positive and then second a negative voltage impulse. Consequently, the system generates a square wave 60′ (FIG. 4(b)) that commences at times t₁,t₃ when the signal 66 rises above the base line B by a given amount and terminates after times t₂,t₄ when the signal drops below the baseline B, each by a threshold amount of say 20% of the peak value of the voltage above and below the baseline. Again, injector opening times T are easily calculated as the difference between times t₁ and t₂ (and t₃ and t₄), as well as engine speed based on the difference TP between t₁ and t₃ (and t₂ and t₄) whereby engine speed is given by 2/TP, assuming a 4-stroke cycle.

Handling of pulses by the control unit is as follows. When a pulse arrives (ie turns on), timing of the pulse duration immediately begins. When the pulse turns off the duration is immediately captured. This duration is then validated. If it is too short or too long to be a valid injection pulse, it is ignored. If the pulse duration is valid, it is stored and assumed to be the first (or only) member of a new pulse group. If a further pulse is detected within a pre-set time, its duration is added to the group total and the pulse count total for the group is updated. If an invalid pulse is detected at any time during the reception of a pulse group, it is simply ignored (ie not added to the duration total or pulse count). If the pre-set time elapses, it is assumed that this is the end of the group of pulses (i.e the end of the injection cycle), at which point the group total duration is validated. If the group total duration is invalid (too short or too long), it is rejected and all group time recordings revert back to any previous valid pulse group. The pre-set time is preferably about 3 milliseconds, which is long enough to be sure that no more pulses can be expected yet short enough to keep the end-of-group reaction time low so that group timings can be quickly acted upon.

Once a valid group of pulses has been captured, the time at which the group started is recorded. After a second valid group has been captured, the time between the start of the first group of pulses and the start of the second group of pulses is measured and validated. If the time is too long or too short, the first group of pulses are rejected and ignored (the second group then effectively becomes the first group relative to any further pulse group(s)).

Once two valid groups of pulses have been captured and the duration between the groups has been validated, a calculation is performed to determine when the next group of pulses can be expected. This calculation uses engine acceleration data, captured during calibration, to provide a pulse group ‘expectation window’ by calculating ‘earliest’ and ‘latest’ arrival times of the next group. If the third group of pulses is valid and arrives when expected, the input is considered to be stable and ‘locked on to’. At this point rpm, load and all fuelling calculations are performed and output of diesel (and/or gas, see below) control begins. If at any point the next group of pulses does not arrive when expected, all ‘lock’ timings are discarded and the input is marked as absent. If this occurs at above-idle engine speeds and/or at a high fuel rail pressure, overrun is assumed, allowing fuel output/control to be suspended while a simulated tacho output is generated. This is required in order to keep any gas system active (see below) until the injection pulses return. If lock is lost at idle or low fuel pressure, this indicates that the engine has stopped running, so all timings are discarded, tacho output ceases and rpm, load, etc are reset to zero.

After validation of a group of pulses, the group pulse count (ie the number of pulses the group contains) is used to calculate the group's total injector latency time (since each injector turn on/off time will be slightly different to the actual fuel flow start/stop time) by simply multiplying the number of pulses by the injector latency (of a single injection). The total latency of the group is then subtracted from the group pulse total duration, giving a more accurate representation of the relative fuel quantity injected.

This system of pulse validation and prediction allows pulses that are too small or that arrive outside of the ‘expectation window’ (such as noise or post-injection pulses) to be ignored giving a very positive and accurate ‘lock’ on the main injection pulses.

As mentioned above, the line 32 from the fuel pressure sensor is cut and fed to the control unit 40. During calibration, the control unit is adapted to reflect exactly the same signal to output port O that it is receiving at input port I. Thus the ECU 14 notes no change by the adaptation of the line 32.

The control unit 40 assumes that the voltage V at the input I is directly proportional to the pressure being sensed, since this is the normal mode of operation of such sensors. That is, P=c·V, where c is some unknown constant.

At a fuel pressure P and an injection opening time T, the volume Q of fuel delivered to the engine at each injection will be given by Q=k·T·√P, where k is another constant. Consequently, a fuel delivery template can now be built by the control unit 40 that is a qualitatively accurate representation of the relative fuel load delivered by the ECU at different engine speeds and workloads imposed. The load imposed on the engine can be assumed and quantified using an arbitrary scale simply by reference to the quantity of fuel delivered at a given engine speed. The fuel delivery template effectively constructed in the control unit 40 commences with an arbitrary “value” of the quantity Q of fuel delivered during idling of the engine under no load 3 units. The unit of this value is obviously of volume, but since the actual amount of fuel injected is unknown and will vary from engine to engine, it is, in any given case, an arbitrary unit. However, with each change in fuel pressure P and injector opening time T a new value of Q as some multiplier of 3 is derived. During this process the engine is run over a range of speeds and loads. For example, the control unit 40 has no real knowledge of when or what the maximum fuel load level is compared with level 3. This is only discovered empirically but the maximum experienced could have a Q value of say 45 (ie 15 times the idling, no load Q value. Depending on the template built, the range of loads from minimum to maximum is then divided into as many bands as there are cells on the template. The same is performed on the orthogonal axis (it is of no consequence which is the x-axis and which is the y-axis) with the engine speeds, dividing the available bands equally over the speed range experienced during calibration. A practical distribution provides 32 by 32 divisions.

It is now possible for the control unit to be changed into an operational mode. Here, instead of reflecting to the output O the same value of voltage that the control unit receives at input I, a modified output signal (that may be greater or lesser than the input signal, depending on what effect is to be achieved), may be provided.

If the purpose of the system 12 is to degrade engine performance, the value reported may be higher than actually received. In that case, the ECU understands that a higher fuel pressure is pertaining in the fuel rail 20 than is in fact the case. The ECU reacts to reduce that pressure, despite its own control algorithm calling for the higher pressure, since it is generally programmed to accept the value reported by the sensor rather than what it should be by its control of the pump and P and valve 22.

If the purpose is to enhance engine performance, the pressure value reported by the control unit 40 is lower than actually received. In that case, the ECU understands that a lower fuel pressure is pertaining in the fuel rail 20 than is in fact the case, and likewise reacts accordingly to increase that pressure.

As mentioned above, there may be a combination of purposes purely to improve engine efficiency in particular applications. Thus, in commercial vehicles, it may be desired to enhance low end torque while decreasing high end performance, whereby the operator is encouraged to employ the engine at low speed, enhancing engine life and fuel efficiency.

However, whatever scheme is employed, the pressure reported by the modification control unit 40 cannot be so extreme (compared to what it actually is) that the ECU assumes some fault condition has arisen and switches the engine to a fault mode (sometimes referred to as “limp-home” mode). Indeed, it is partially because this can happen that it is valuable to be able to adjust any such modification map to reduce the possibility of invoking a fault condition at given speeds and loads.

The present invention proposes a modification map 80 (see FIG. 6) that overlies the template described above to produce an output voltage Vₒ at the output port O according to the calculation:

Vₒ=x·Vᵢ
where Vᵢ is the voltage at the input and x is the value in the modification unit to be pertaining in the engine at the time.

Thus, if the engine is operating at 1250 rpm (referring to FIG. 6) and the fuel load requested by the ECU represents load level 5, then the value of the cell 82 in the map 80 with those co-ordinates (eg 1.05), is used as the modifier for the fuel pressure signal to be transmitted to the ECU. The values in the modification map 80 are arranged to be selectively changeable by a user. Preferably, a display 90 is attached to, or is part of, the control unit 40 and comprises a screen 92 and knobs 94. However, it should be understood that a connection for a personal computer may be provided where the map may be modified online and transmitted to the unit 40. However, one application employs the screen 92 to display an approximation map 100 (see FIG. 7) which represents an approximation of the modification map 80 for the purposes of user input. The map is divided into a limited number of engine loads (High, Medium and Low) and a limited number of engine speeds (Idle to 5). The knobs 94 (which may be buttons, dials or keypads etc, as desired) permit adjustment of the values in each of a limited number of cells 102, smaller in number than the number of cells 82 in the modification map 80. A menu system may be provided in software to enable adjustment of parameters.

The control unit can be arranged to store a number of different approximation maps and a first of them might be entitled “Normal” or some similar name and will have all values of 100 whereby the underlying modification map will have all its cells 82 filled with 1.00. That will result in the output voltage of the control unit being exactly matched with the input voltage, whereby there is no modification of the engine running parameters. However, there may be other maps entitled “Enhanced” or “Degraded” that have different values. One enhanced form is shown in FIG. 7. The control unit smoothes out changes between cells 102 when interpolating the modification map 80 from the approximation map 100. Thus, in a vertical direction, for example, given the arrangement of FIG. 7 with the approximation map, the modification map at speed 1250 may read from loads 1 to 10: 1.00, 1.01, 1.02, 1.03, 1.04, 1.06, 1.06, 1.08, 1.09, 1.10. A similar transition may apply across the table. It is to be noted that these numbers are purely illustrative (as are the numbers in the tables in FIGS. 6 and 7). Different numbers may be used, such as five digit integers. The important point is their relative values; the control unit can convert them into useable values separately for modifying the pressure level to be reported to the ECU.

Turning back to FIG. 1, a pocket-sized display 90′ may additionally or instead be provided, the display 90 being used merely to set up the kit during installation. Display 90′ may simply be a means of selecting between different operating modes with simple LEDs 92′ serving as the screen and buttons 94′ serving to change modes. Conveniently, display 90′ is in the form of a key fob, communicating wirelessly with the control unit 40.

One application of the present invention is to enable downgrading of engine performance, which parents may particularly value in permitting children to drive their vehicles, and which indeed may permit young people to acquire insurance for vehicles they are not normally permitted to drive. In that event, the buttons 94 may include the capacity to enter a unique code so that only those possessing the code can change operational mode. Preferably, a log is included in the kit to record modes of operation with a time and date stamp of changes. Such log enables subsequent interrogation of the kit to establish in what mode of operation the vehicle has been used in a given time frame.

Finally, as described above, another application of the kit is in association with a dual fuel conversion. Dual fuel conversions are reasonably common on petrol engine cars but, with the increase in duty payable on diesel fuel it also makes sense with diesel engines. There is also the possibility that employing gas assists better and more complete combustion of diesel fuel. Which secondary fuel is employed is a matter of choice, between liquefied petroleum gas (LPG), compressed natural gas (CNG) or even hydrogen. Indeed, hydrogen may be supplied from a fuel cell, rather than a tank.

In the context of the present invention, the modification kit 12 is installed as described above without change. The only difference is that the degree of adjustment of the fuel load may be more substantial whereby the over-reporting of the fuel pressure may be extensive (eg 120%). However, the system installed also includes a (standard) gas conversion kit 120 (see FIG. 5). By “standard” is meant potentially an existing system already available on the market. This system comprises a fuel supply 124 connected to injectors 126 that are positioned in the air intake manifold 128 of the engine as close to air inlet valves (not shown) of the respective cylinders as possible. Four are implied (as indeed they are in FIG. 1, but the invention is not limited to any number of engine cylinders). Lines 110, 122 connect the modification control unit 40 of the present invention to a gas control module 122 of the secondary fuel system 120.

Most gas systems presently available on the market are intended for petrol engines. Petrol engines, as mentioned above, have low fuel pressure which is substantially constant, whereby different fuel quantity injection is controlled almost exclusively by injector opening times. The systems work by breaking into the leads to the injectors and plugging them into ports 132 in the gas module 122. The module has output terminals 130 for leads (not shown) that send a modified opening signal to the diesel injectors, but these are not used in the present arrangement. The gas module 122 also controls by the gas injectors 126. A tacho input 112 is also normally provided on the module to inform the gas system that the engine is still running. Of course, in overrun situations, the opening signals to the normal fuel injectors may disappear.

However, with the present invention, there is no requirement to break into the fuel injector lines 16, since the module 40 handles that. Instead, the module 40 is provided with outputs 41 to which the lines 110 are connected, they being plugged into the ports 132 of the module 122. The data supplied by the line 110 is simply a dummy opening time signal that may be produced by any engine ECU with fuel injection. The module 40 also produces a tacho signal. From this information, the module 122 may indeed issue a modified signal to outputs 130, (but these are not used), but it also determines how much gas to inject according to its own algorithm, (and based on the “timing signals” it receives on lines 110 perceiving them as fuel injector opening times and hence injection quantities) and controls the gas injectors 126 accordingly.

In order to control the gas injection, however, the module 40 is also provided with a gas map (not shown) that equates to the modification map in terms of locations for different load and speed combinations. For a given load and speed of the engine, the gas map issues a timing signal to line 110 dependent on the values stored in the gas map at that load and speed. That gas map is equally capable of manipulation, as is the modification map 80) by the user to adjust the “apparent” timing signal to be issued dependent on load and speed. Consequently, the arrangement provides for precise control of the gas injection.

Also within the ambit of the present invention is a control signal for gas generation. This applies in the case of hydrogen being used as the secondary fuel. The hydrogen may be generated by a fuel cell (not shown) whose operation may be controlled by an alternating signal that switches it on and off. Using pulse width modulation (or any suitable technique) the volume of hydrogen to be generated can be controlled and such a signal can be produced by the control module 40 depending on the demand for secondary fuel.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A performance modification/tuning kit for an internal combustion engine of the type comprising:
a common fuel supply rail for a plurality of combustion chambers of the engine;
a fuel injector for each combustion chamber, each injector supplied by the common rail;
an engine management control unit (ECU) that controls the pressure of fuel in the common rail;
a pressure sensor that monitors the pressure of fuel in the common rail and reports a pressure signal generated by the sensor on a pressure signal line to the ECU; and
a control line from the ECU to each injector to control the opening of each injector, whereby the load Q of fuel injected is dependent on the total opening time of the injector and the fuel pressure in the common rail;
wherein the kit comprises:
a kit control unit;
an electrical sensor adapted to detect the opening and closing signals of the control line to one of the injectors of the engine and connected through a sensor line to the control unit;
an input to receive the signal from the pressure sensor;
an output to report a generated pressure signal; and
a selectively changeable modification map comprising modification values for a range of different engine speeds and fuel loads demanded by the ECU, wherein
the kit control unit generates said generated pressure signal in dependence upon the value in the modification map for the engine fuel load Q currently demanded by the ECU and the engine speed currently pertaining from time to time.

2. A tuning kit as claimed in claim 1, in which, when the kit is connected to an engine with the sensor line interrupted and connected from the sensor to the kit control unit input and from the ECU to the kit control unit output, the control unit is adapted to monitor engine speed and instantaneous fuel load based on the opening and closing signals of the sensed injector and the reported fuel pressure;
initially the control unit is adapted to be calibrated by operating the engine in a normal mode, wherein the generated pressure signal is a duplication of the reported pressure signal, and a template for the modification map is developed being a table of fuel load versus engine speed divided in bands between maxima and minima of each of fuel load and engine speed experienced during calibration; and
after calibration, the control unit is adapted to be set in one of several selectable operating modes, wherein the modification map is applied, whereby, at any given engine speed and load, a modification value in the map is applied to adjust the value of the pressure signal received from the pressure sensor and issue the value generated thereby to the ECU through said output.

3. A tuning kit as claimed in claim 2, in which the operating modes that incorporated in the kit include:
a normal mode, where the modified pressure signal corresponds to the delivery map and no change in engine performance ensues;
one or more enhanced performance modes, where the modified pressure signal is changed so as to under-report the pressure actually pertaining in the common rail, whereby the engine management system will increase fuel pressure according to its own parametrics; and
one or more detracted performance modes, where the modified pressure signal is changed so as to over-report the pressure actually pertaining in the common rail, whereby the engine management system will decrease fuel pressure according to its own parametrics.

4. A tuning kit as claimed in claim 2, in which a mixed performance operating mode is provided in which fuel delivery is increased at high loads and low speeds, enhancing low speed torque of the engine, whereas at high speed the fuel delivery is reduced.

5. A tuning kit as claimed in claim 1, in which the kit includes a display and operator interface, connectible to the control unit, whereby the modification map may be modified by a user of the kit.

6. A tuning kit as claimed in claim 5, in which the display enables an approximation of the modification map to be displayed.

7. A tuning kit as claimed in claim 5, in which the display is not textual but comprises only may be lights and/or sounds that indicate the modification map currently being applied.

8. A tuning kit as claimed in claim 5, in which the operator interface comprises one or more switches or a keypad enabling selection of a modification map.

9. A tuning kit as claimed in claim 5, in which said modification map comprises m by n fields or cells and said approximation map comprises a by b fields where m, n, a and b are integers and each field (m, n) of the modification map is an interpolation of values from the approximation map.

10. A tuning kit as claimed in claim 1, in which the sensor connected to the control unit that detects the opening and closing signals of the control line to an injector of the engine detects the presence of a voltage or current in the control line without interrupting the control line.

11. A tuning kit as claimed in claim 10, in which the sensor is a Hall effect device, where the issued voltage is proportional to the strength of the detected field.

12. A tuning kit as claimed in claim 10, in which the sensor is contained within a metallic package closable around the control line to shield the magnetic sensor from the effects of other magnetic and electric fields in the vicinity of the control line.

13. A kit as claimed in claim 12, in which the sensor is fixed in a channel formed by a first metal plate to which a second metal plate is hinged, whereby the shield can be closed around a selected control line engaging the control line against the sensor and locking the sensor to the control line.

14. A tuning kit as claimed in claim 1, in which the control unit is adapted to be calibrated by firstly shaping the issued voltage from the sensor by amplification and offsetting to fit in the voltage envelop of the kit's control unit, and secondly averaging the voltage and detecting whether significant deviations from the average value occur both above and below the average or just one side.

15. A tuning kit as claimed in claim 1, in which, during normal operation pulses and/or groups of pulses, detected by the electrical sensor are validated by the system before being considered to reflect an injector opening event.

16. A tuning kit as claimed in claim 15, in which the validation occurs when pulses arrive within an expectation window, which window is created by recording during the calibration phase acceleration and deceleration performance of the engine to permit prediction, given immediate past performance, when the next pulse would be expected.

17. A tuning kit as claimed in claim 1, further comprising a secondary fuel kit including:
a supply of secondary fuel;
a gas control module;
gas injectors controlled by the gas control module;
wherein the gas control module is adapted to receive timing signals indicative of an opening time of the fuel injectors which timing signals are generated by the tuning kit control unit; and
wherein the modification kit control unit further comprises a gas map of values for each of a plurality of engine speed and loads, which values determine the duration of said timing signals whereby the injection of said secondary fuel is controlled by said tuning kit

18. (canceled)
